(19) United States
(12) Patent Application Publication
(10) Pub. No.: US 2006/0126107 A1
(43) Pub. Date: Jun. 15, 2006

(54) Wear-based load-balancing for production networks

(75) Inventors: Patrick C. Cheung, Castro Valley, CA (US); Juan Liu, Milpitas, CA (US); Tracy E. Thieret, Webster, NY (US)

Correspondence Address: PATENT DOCUMENTATION CENTER, XEROX CORPORATION, 100 CLINTON AVENUE SOUTH, XEROX SQ. 20 TH FLOOR, ROCHESTER, NY, 14644, US

(73) Assignee: Palo Alto Research Center Incorporated.

(21) Appl. No.: 11/011,667

(22) Filed: Dec. 14, 2004

(51) Int. Cl. G06F 3/12

(52) U.S. Cl. 358/1.15

(57) ABSTRACT

A computerized method is presented for the management of job distribution among a population of networked production machines through balancing of the usage load over the population of networked machines based upon wear data. The method includes initializing a production server, which communicates with the networked production machines. The wear rate for each monitored component within each machine is synchronized, as is the residual life for each monitored component. The residual life value for each networked production machine is communicated to the production server. A determination is made as to whether a job request has arrived, and production machine(s) are selected to perform the job, with selection based on the state of wear of each networked production machine and the wear policy being applied to the network. The residual life values for the selected production machine(s) are updated based on the requirements of the job.

### INCORPORATION BY REFERENCE

The following U.S. patents are fully incorporated herein by reference: U.S. Pat. No. 6,687,018 (“System and Method for Distributing Print Jobs”); U.S. Pat. No. 6,498,656 (“Rule Based Selection Criteria for Controlling Print Job Distribution”); U.S. Pat. No. 6,373,585 (“Load Balancing for Processing a Queue of Print Jobs”); U.S. Pat. No. 6,145,031 (“Multiple Insertion Point Que to Order and Select Elements to be Processed”); and U.S. Pat. No. 5,897,260 (“Print Job Allocation System”).

### BACKGROUND

This disclosure relates generally to a method and system for management of job distribution among a population of networked production machines and, more particularly, to balancing the usage load over networked production machines based upon the wear data of individual members of the networked production machines.

Networked printing systems generally comprise an assemblage of different printers, client computers, servers, and other components connected over a network. A print job may be assembled at a client computer and transmitted over the network to a server linked to a variety of printers, which may have differing printing capabilities. The server routes the print job to the printer whose capabilities match the requirements of the submitted job. However, in such a network some printers may require more frequent maintenance than others as the result of increased wear.

For example, when copiers are deployed at a self-service copy shop, the copier nearest the entrance often experiences wear-related problems most frequently due to its higher rate of usage by customers. This may result in frequent service calls, higher maintenance costs, and customer dissatisfaction. Given an estimate of the wear rates of the various copiers in a shop, such as provided by copy counts or more sophisticated analysis of the copiers' operation, users could be directed to copiers in order to produce a more desirable wear pattern.

Currently, maintenance providers view individual printers as the central entity for offering maintenance services. Usually, a maintenance call is made when a printer fails to accomplish one task and service has to be provided on that basis. It is possible that the task at hand can be accomplished by other printing devices in the network and/or that the specific printer can accomplish other tasks. Although the current trend has been to focus on customer printing solutions rather than individual printers, in the presence of wear or faults, the printing solution degenerates into individual printers that require maintenance. It would be useful to have a method and system for balancing the usage load over a network of equipment based upon the wear of individual members of the network.

### BRIEF SUMMARY

The disclosed embodiments provide examples of improved solutions to the problems noted in the above Background discussion and the art cited therein. There is shown in these examples an improved computerized method for the management of job distribution among a population of networked production machines through balancing of the usage load over the population of networked machines based upon wear data. The method includes initializing a production server, which communicates with the networked production machines. The wear rate for each monitored component within each machine is synchronized, as is the residual life for each monitored component. The residual life value for each networked production machine is communicated to the production server. A determination is made as to whether a job request has arrived, and production machine(s) are selected to perform the job, with selection based on the state of wear of each networked production machine and the wear policy being applied to the network. The residual life values for the selected production machine(s) are updated based on the requirements of the job.

In another embodiment, there is presented a computerized system for the management of job distribution among a population of networked production machines through balancing of the usage load over the population of networked machines based upon wear data of the networked production machines. A production server, in communication with the networked production machines, includes a wear estimation module for synchronizing wear rate and residual life for each monitored component within each networked production machine. A residual life module communicates the residual life value for each networked production machine to the server. A job routing module receives job requests and selects the production machine(s) to perform a job, with selection based on the state of wear of each networked production machine and application of a wear policy. A data mapping module updates the residual life values for the selected production machine, with the updated accumulated wear values being a more detailed estimate of incremental wear on the selected production machine based on the requirements of the job.

In yet another embodiment, there is provided an article of manufacture in the form of a computer usable medium having computer readable program code embodied in the medium which, when the program code is executed by the computer, causes the computer to perform method steps for the management of job distribution among a population of networked production machines through balancing of the usage load over the population of networked machines based upon wear data of the production machines. The method includes initializing a production server, which communicates with the networked production machines. The wear rate for each monitored component within each machine is synchronized, as is the residual life for each monitored component. The residual life value for each networked production machine is communicated to the production server. A determination is made as to whether a job request has arrived, and production machine(s) are selected to perform the job, with selection based on the state of wear of each networked production machine and the wear policy being applied to the network. The residual life values for the selected production machine(s) are updated based on the requirements of the job.

### BRIEF DESCRIPTION OF THE DRAWINGS

The foregoing and other features of the embodiments described herein will be apparent and easily understood from a further reading of the specification, claims and by reference to the accompanying drawings in which:

FIG. 1 is a flow chart for one embodiment of the method for resource utilization based on wear balancing;

FIG. 2 is an example embodiment of a print system utilizing wear-based load-balancing to produce a more desirable wear pattern;

FIG. 3 is a flow chart for one embodiment of the method for resource utilization based on a combination of wear balancing and reverse wear balancing; and

FIG. 4 is an example embodiment of a print system utilizing wear-based and reverse wear-based load balancing to produce a more desirable wear pattern.

### DETAILED DESCRIPTION

Printers as part of the Information Technology infrastructure of a company enable new prognosis, diagnosis, and maintenance technologies. Networked printers in a customer site can exchange data using the existing network without privacy or security concerns as would be the case with sending such information to an external location. For example, every morning printers can broadcast their wear status in order to determine a plan for distributing the print jobs in the network. An underlying assumption in the deployment of a wear-balancing print server routing scheme is that by clustering service calls to all or a subset of printers a department's service costs would be reduced as service calls are consolidated. From the viewpoint of the servicing company, technicians would be more efficiently utilized, since less time would be expended on transportation to and from customer sites.

A desirable wear pattern may cause all machines to wear at the same rate, allowing maintenance to be scheduled at the same time for all machines, or might direct usage to machines for which consumables are in stock. The problems of managing usage to optimize wear appears in networked printers, parallel printers, equipment rentals, and other scenarios where there is a collection of equipment that can be managed as a single pool.

The system and method apply to control software used for multi-step production processes such as manufacturing, printing, or assembly and provide for the handling of complex operations over complex paths to provide job routing based on machine wear data. Although, for the purposes of descriptive discussion, the following embodiments are presented within the context of a print system, it is noted that the system and method herein disclosed may be beneficially employed in any of numerous fleets of production machines, such as copiers, automobiles, and military equipment, among others. Utilization of the system and method herein in all such applications is fully contemplated by the specification and scope of the claims herein. In the following description numerous specific details are set forth in order to provide a thorough understanding of the system and method. It would be apparent, however, to one skilled in the art to practice the system and method without such specific details. In other instances, specific implementation details have not been shown in detail in order not to unnecessarily obscure the present invention.

Various computing environments may incorporate capabilities to provide job routing based on machine wear data. The following discussion is intended to provide a brief, general description of suitable computing environments in which the method and system may be implemented. Although not required, the method and system will be described in the general context of computer-executable instructions, such as program modules, being executed by a single computer. Generally, program modules include routines, programs, objects, components, data structures, etc. that perform particular tasks or implement particular abstract data types. Moreover, those skilled in the art will appreciate that the method and system may be practiced with other computer system configurations, including hand-held devices, multi-processor systems, microprocessor-based or programmable consumer electronics, networked PCs, minicomputers, mainframe computers, and the like.

The method and system may also be practiced in distributed computing environments where tasks are performed by remote processing devices that are linked through a communications network. In a distributed computing environment, program modules may be located in both local and remote memory storage devices.

Although the method and system described herein are not limited to embedded applications, the following discussion will pertain to embedded systems for purposes of example only. One skilled in the art will appreciate that the provision of job routing based on machine wear data is useful for many complex control problems and generic software solutions to a wide variety of machine control problems, among others. Additionally, it may be practiced in a multitude of computing environments.

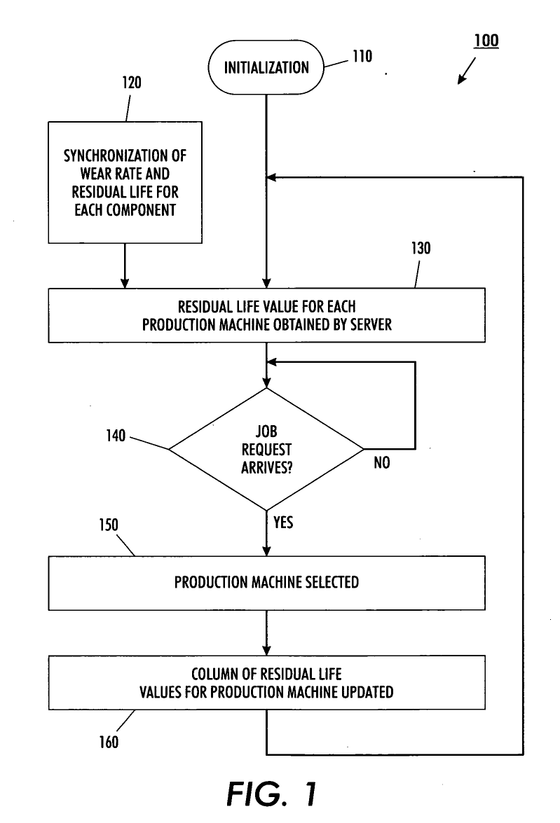

In FIG. 1, a flow chart illustrates one embodiment of the method for resource utilization based on wear balancing. The printer network is powered on at 110 and the print server is initialized. Periodically, each printer synchronizes the wear parameters to the print server for each of its components being monitored at 120. Depending on the specific type of wear policy that a customer may want to enact, Customer Replaceable Units (CRU) or other consumables such as toner bottles or paper supplies can be included as wearable components. Some of these components may be embedded in a subassembly that is replaced as a unit, thus the wear parameters of that subassembly may be synchronized instead. Each component is described by three wear parameters: Residual Life, Service Life, and one or more modifiers, which are represented in a component wear table similar to Table 1.

Each component, denoted by subscript i, has a known Service Life, HLifei, when initially installed. As the component experiences use, it sustains wear and its remaining service life decreases. Typically there is a different wear rate for each of the components. However, in the method and system described herein, all components are tracked in production units, and for the example of the printer network, in units of pages to permit comparisons, thus wear rate equals unity for all components. In cases where specific components, for example, toner bottles (in units of pixels), are more appropriately modeled in other units, a modifier, k, is used to translate the amount of wear into units of pages. The Residual Life, Hi, is an estimate of the amount of remaining service life. The Service Life values and the Residual Life values of all components are expressed and compared in units of pages. The use of page counts also facilitates comparisons across different printers. When modeled accurately, a component that has the least Residual Life will fail earliest, rendering its associated printer incapable of completing a specific job. Therefore, the state of wear of a printer W, is expressed as the number of pages remaining that the component with the least residual life is expected to deliver.

TABLE 1
Component wear table for a single printer

| | | Residual Life | Service Life |
|---|---|---|---|
| | Modifier | (in # of pages) | (in # of pages) |
| Motor 1 | k₁ | H₁ | H_{Life1} |
| Roller 1 | k₂ | H₂ | H_{Life2} |
| Motor 2 | k₃ | H₃ | H_{Life3} |
| Roller 2 | k₄ | H₄ | H_{Life4} |
| . . . | | | |
| Toner | k₅ | H₅ | H_{Life5} |
| Bottle | | | |
| Power | k₆ | H₆ | H_{Life6} |
| Supply | | | |

The final parameter is a multiplicative modifier, k, which is applied based on the condition of the machine. The modifier may also be the product of more than one modifier when there are multiple machine conditions affecting component wear. For example, when a machine experiences a cold start, the value of k may increase slightly to account for the resulting additional wear. Hence, for each component i,
H=H_{old}−k*N, (Equation 1)
where initially H_{old}=H_{Life}, both in units of pages, and N represents the number of print pages. Some components whose service life values are originally measured in other units will require the multiplicative modifier to convert the measurement into units of pages. For example, a toner bottle's capacity is directly proportional to the number of pixels printed. Based on a pre-selected value, M, of average number of pixels per page, the bottle's service life is first converted to an equivalent number of pages printed. Then, for each job printed, the actual number of pixels applied to the entire job is divided by M*N to obtain the multiplication modifier, k. The modifier can then be applied in Equation 1 to convert the amount of toner usage as number of pages being taken out from the residual life H_{old}.

There may be some components for which it is difficult to determine an accurate life. For example, it may be difficult to determine the life of a photoreceptor belt as accurately as the life of a toner bottle. Usability of a life estimate may be improved through use of a conservative figure for the life of the belt to guarantee that the belt will operate properly as long as the residual life value is larger than zero. Alternatively, a continual adjustment of the residual life or wear rate based on other techniques for wear measurements may result in closer residual life estimates. For example, the printer manufacturer may, through the Internet, collect real-time wear data from thousands of similar printers and use data mining techniques to calculate and update wear parameters. In 130, for each printer i the minimum value among the residual life values of all the components within that printer is used to represent the state of wear, Wi, of that printer, such that
Wᵢ=MIN(H₁, H₂, H₃, . . . ) (Equation 2)

A determination is made as to whether a print request has arrived at 140. If a request has not arrived, the system continues to recheck the print request status until a print request is received. At 150 the print server routes jobs to different printers based on the state of wear of each printer and the use of a decision algorithm that shapes the wear pattern across all printers according to a wear policy. An example wear policy is minimization of the wear variance among the printers. A second example wear policy would incorporate a preference to use printer types for which consumables are on hand. Alternatively, the parameters in the wear table can also be modulated by weights that incorporate optimization of other user preferences, which may include preferences for a particular printer, media, location, print quality, or corporate user quota.

A simple method to achieve minimization of the wear variance among printers is to have the print server evaluate
MAX(W₁, W₂, W₃, . . . ) (Equation 3)
to select the printer with the longest component Residual life. The above evaluation and resulting printer selection may be performed quickly because the evaluation does not rely on extensive computations or further data from the printers. While this evaluation is generally accurate, there is a possibility that a specific job may cause heavier wear to a component other than the one with minimum Residual Life. There is also the possibility that the requirements of an incoming job exceed the remaining resources of a printer, for example, print toner may be completely consumed prior to job completion. If further accuracy is required in printer selection, an alternate algorithm may be utilized (as described with reference to 160 hereinbelow), that first computes a predictive wear estimate for one or more printers before a printer is selected.

At 160, after the print job has been routed to the selected printer, the server will compute a more detailed estimate of the incremental wear on the selected printer. Based on the size and other requirements of the print job the server determines a set of job parameters for that specific job. The set of job parameters includes the number of pages to be printed, whether the pages are to be printed simplex or duplex, and the number of pixels for each toner color. Using the job parameters the server can evaluate the k*N portion of Equation 1 on all the wearable components within the selected printer. The wear estimates in turn are used to update the residual life entries in the component wear table when Equation 1 is completely evaluated. The resulting component Residual Life values are forwarded to 130 where the Residual Life values are applied to Equation 2 to determine the new Wi of the selected printer. At the next scheduled synchronization these estimates will be discarded, and the selected printer will supply an accurate set of wear parameters to the print server.

It is noted that in each of the printers connected to the server there may be a wear-estimation module similar to 160 that tracks the residual life values of all the wearable components. By using additional information only available to the printer itself, this module can make the best assessment to determine residual life values. Such additional information includes ambient temperature and moisture measurements that will affect component longevity. If the printer has been used as a copier in between server synchronization the actual residual life values will also decrease accordingly.

It is further noted that not all printers in the network need to be equipped with the wear estimation module in order for the wear balancing system and method to operate. The wear balancing system and method on a server may operate with participation by a subset of two or more printers in the network. While the purpose of optimizing for the number of service calls may not be satisfied, flexibility exists for the customer to pace printer upgrades in the network according to specific budget plans. Similarly, the reverse wear balancing system and method as described hereinbelow may be implemented with participation from a subset of printers in the network. However, for the purposes of this discussion, all printers in the network are assumed to be participating.

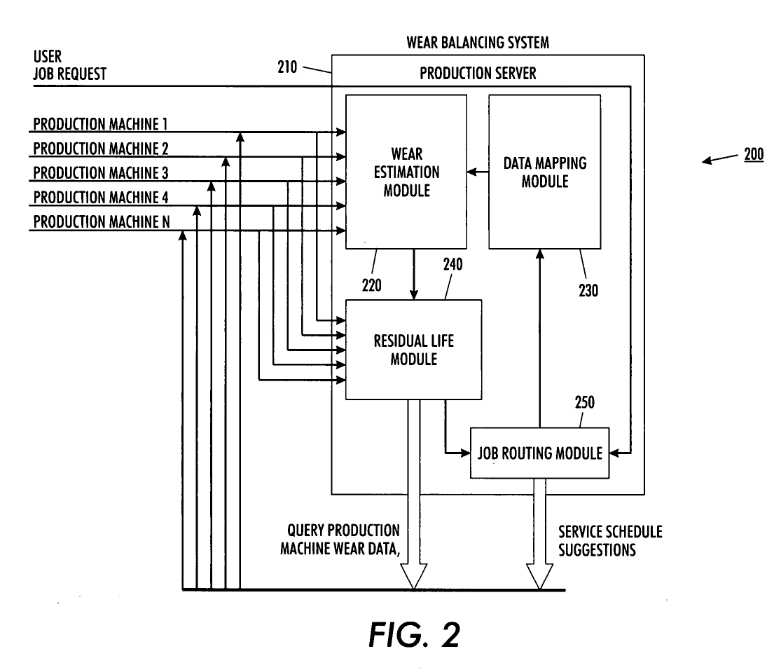

Turning now to FIG. 2, there is illustrated one embodiment of an example system 200 for utilizing wear balancing to manage sets of interchangeable resources, such as networked printers at a customer site. In this example embodiment, the wear balancing system resides within a print server 210.

When a print job request arrives at the server, Job Routing Module 250 accesses the most recent state-of-wear values from Residual Life Module 240 and evaluates Equation 3. A printer is selected and the job is forwarded to the selected printer. A copy of the print job is sent to Data Mapping Module 230 where job parameters corresponding to the specific print job are extracted. The job parameters extracted by Data Mapping Module 230 include the number of pages to be printed, whether the pages are to be printed in simplex or duplex, and the number of pixels for each toner color. These values will be used in variables k and N in subsequent evaluations of Equation 1. Preferably, the job parameters are supplied with the print job. However, some jobs may not include these parameters, requiring Data Mapping Module 230 to analyze the job content and compute the job parameters on the server. The job parameters are forwarded to Wear Estimation Module 220 for further processing.

Periodically, each printer in the printer network provides updated wear information to Modules 220 and 240 to populate Table 1. With this information and the parameters received from data mapping module 230, Wear Estimation Module 220 evaluates Equation 1 on each of the wearable components in the previous selected printer and updates the Residual Life estimate of each component on Table 1. Additionally, because of the various ways modifier k may be defined, if a component receives a modifier from the printer and another one from Wear Estimation Module 230, then the two modifiers are multiplied together and the product applied to Equation 1. Residual Life Module 240 shares the Residual Life column entries of Table 1 and will evaluate Equation 2 for each printer, as soon as new Residual Life data for that printer is available. During the periodic updates the wear information from the printer will supersede the corresponding entries in Table 1. The Residual Life estimates computed by the server between printer updates then may be discarded, since they are less accurate than those supplied by the printer. The state-of-wear values for all printers will in turn be available for Module 250 when the next print job arrives. Finally, based on the state-of-wear values of all the printers and average job sizes the server can predict when a printer will fail and also provide the customer with a suggested service schedule.

A well-executed Wear Balancing scheme requires that the printer manufacturer provide accurate wear parameters for all wearable components in a printer. However, not all parameters may be measured accurately, or there may be randomness in the quality of the components, leading to pre-mature failures. In many printer configurations a premature failure of any components usually results in the cessation of all functionality by the printer until service is provided. Typically, jobs first designated for the non-operating printer are then shared among the remaining printers in the network. Until the failed printer is restored to service, the increased workload will undesirably increase wear to the remaining operating printers. Since the aggregate printer throughput of the server is reduced, there may be a requirement for single-printer service visits. Consequently, a wear-balancing scheme alone may not always achieve its purpose of reducing service calls.

To address these uncertainties the diagnostic capabilities of the printers and the server may be enhanced. Because a component failure may not always render a printer completely inoperable, it is desirable for the affected printer to continue to operate within its now reduced means. In the following discussion, such affected printer will be referred to as a “disadvantaged” printer. In an alternate embodiment, the server may route jobs taking into consideration the reduced performance range of the disadvantaged printer to balance the wear equation. The term “reverse wear balancing” is used to describe such operation. This embodiment results in less disruption to the original wear balancing scheme and less interruption in network printer performance. The aggregate throughput with a Reverse Wear Balancing scheme will be higher than if the disadvantaged printer is considered damaged and removed from service.

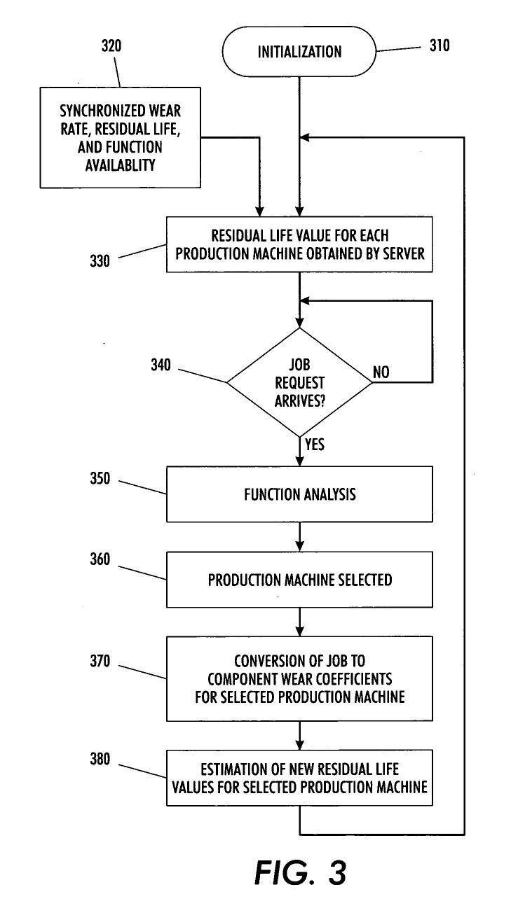

In FIG. 3, a flow chart illustrates one embodiment of the method for resource utilization based on wear and reverse wear balancing. The printer network is powered on at 310 and the print server is initialized. Periodically, each printer synchronizes the wear parameters to the print server for each of its components being monitored at 320. The wear parameters are represented in Table 1 and are defined hereinabove with respect to 120 in FIG. 1. Depending on the specific type of wear policy that a customer may want to enact, Customer Replaceable Units (CRU) or other consumables such as toner bottles or paper supplies can be included as wearable components. Some of these components may be embedded in a subassembly that is replaced as a unit, thus the wear parameters of that subassembly may be synchronized instead.

In this Reverse Wear Balancing embodiment, each of the printers on the network also reports all the print functions that are available when the printer is initially connected to the server, and also when any function availability changes. In this embodiment, resources in a printer are also included and considered in the same manner as print functions. These functions and resources are monitored by a diagnostic module inside the printer. Printer resources and functionality included in reverse wear balancing include, but are not limited to, failures in the duplex path while the simplex path remains operable, deficiency of toner for one or more colors in a color printer, paper jams at one or more input trays, presence of transparencies and envelopes, large format paper requirements, high quality paper stock, and stapling capability. For each printer whose performance is being monitored, a function table similar to that in Table 2 can be found in the server. Thus, the server monitors both component wear and function availability of each printer by tracking the entries in Tables 1 and 2 for the corresponding printer.

TABLE 2
Function Table for a single printer

| Printer resources and functionality | Available |
|---|---|
| Simplex printing | True |
| Duplex printing | False |
| Tray 1 | True |
| Tray 2 | True |
| Black toner | True |
| Red toner | False |
| Envelopes | False |
| Transparencies | True |
| 11 × 17 inch paper | False |
| Acid-free paper | False |
| Function 9 | True |
| Function 10 | True |
| . . . | |

In 330 the server collects the latest Residual values for each printer to be ready for an incoming print job. Then in 340 the server evaluates whether a print job has arrived. If a print job has not arrived, it continues to wait, and continues to update Tables 1 and 2 for each printer when component wear and function availability data arrive at the server. Similar to Equation 2, the least Residual Life among all the wearable components will be used as the state of wear of the printer. However, if a function is not available, and if a component only wears out when that function is performed, then this specific component is no longer wearable. For example, a solenoid controlling a roller in the duplex path will not experience wear if the duplex function is not available. Hence, the server will re-evaluate
Wᵢ=MIN(Hⱼ, Hₖ, . . . ) (Equation 4)
where j,k, . . . correspond to the subset of components that are being utilized in functions available.

When a print job arrives, at 350 the server analyzes the content of the print job and determines resource and printer function requirements. For example, the job may require a duplex output on large format paper, using only black and red toner colors. Preferably these requirements are clearly specified near the beginning of the job data stream. Otherwise the server will analyze and perhaps emulate the entire job content to extract a list of resources and functions. The resources and functions required by the print job are matched against those listed on Table 2 for every printer in the network. Only a list of the subset of printers that fulfills all the requirements is forwarded to 360.

At 360 a printer is selected for the print job according to the customer's wear policy. An example wear policy is minimization of the wear variance among the printers. A simple method to achieve minimization of the wear variance among printers is to have the print server evaluate
MAX(Wₘ, Wₙ . . . ) (Equation 5)

where m,n, . . . correspond to the subset of printers that fulfill the print requirements as determined at 350. When a wear policy demands a more accurate selection of printers, the method outlined hereinabove with respect to 150 and 160 can be applied.

At 370, after the print job has been routed to the selected printer, the server will compute a more detailed estimate of the incremental wear on the selected printer. Based on the size and other requirements of the print job the server will determine a set of job parameters for that specific job. The set ofjob parameters includes the number of pages to be printed, whether the pages are to be printed simplex or duplex, and the number of pixels for each toner color. Some of these parameters may have been obtained at 350. Using the job parameters the server can now evaluate the k*N portion of Equation 1 on all the wearable components within the selected printer. At 380, the wear estimates are used to update the residual life entries in the component wear table when Equation 1 is completely evaluated. The resulting component Residual Life values are forwarded to 330 where the Residual Life values are applied to Equation 4 to estimate the revised state of wear of the selected printer. At the next scheduled synchronization these estimates will be discarded, and the selected printer will supply an accurate set of wear parameters to the print server. Wear estimates from 370 will not change the functionality of the selected printer and hence will not alter Table 2.

It is noted that in each of the printers connected to the server there may be a wear-estimation module similar to 370 that tracks the residual life values of all the wearable components. By using additional information only available to the printer itself, this module can make the best assessment to determine residual life values. Such additional information includes ambient temperature and moisture measurements that will affect component longevity. If the printer has been used as a copier in between server synchronization the actual residual life values will also decrease accordingly.

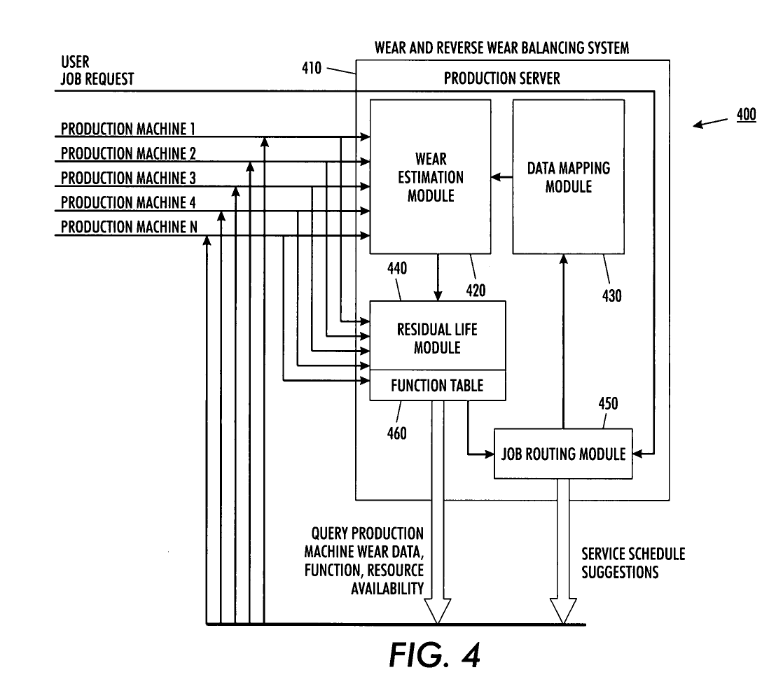

Referring now to FIG. 4, there is illustrated one embodiment of an example system 400 for utilizing wear and reverse wear balancing to manage sets of interchangeable sets of resources, such as networked printers at a customer site. In this example embodiment, the wear balancing system resides within a print server 410.

When a print job request arrives at the server, Job Routing Module 450 first acquires the resource and function requirements for the job and from Table 2 identifies a subset of the printers capable of fulfilling these requirements. Table 2 is maintained by Function Table Module 460 and is created when a printer is first connected to the server; subsequently the printer updates Table 2 as soon as a resource or function availability has changed. Module 450 accesses the most recent state-of-wear values from Residual Life Module 440 and evaluates Equation 5. The job is then forwarded to the selected printer. A copy of the print job is sent to Data Mapping Module 430 where key parameters are extracted to be used to estimate component wear. The job parameters extracted by Data Mapping Module 430 are the number of pages to be printed, whether the pages are to be printed single-side or double-side, and the number of pixels for each toner color. These values will be used in variables k and N in subsequent evaluations of Equation 1. Preferably, the job parameters are supplied with the print job. However, some jobs may not include these parameters, requiring Data Mapping Module 430 to analyze the job content and compute the job parameters on the server. The job parameters are forwarded to Wear Estimation Module 420 for further processing.

Periodically, each printer in the printer network provides updated wear information to Modules 420 and 440 to populate Table 1. With this information and the parameters received from Data Mapping Module 430, Wear Estimation Module 420 evaluates Equation 1 on each of the wearable components in the previous selected printer and updates the Residual Life estimate of each component on Table 1. Additionally, because of the various ways modifier k may be defined, if a component receives a modifier from the printer and another one from Wear Estimation Module 430, then the two modifiers are multiplied together and the product applied to Equation 1.

Residual Life Module 440 shares the Residual Life column entries of Table 1 and will evaluate Equation 4 for each printer, as soon as new Residual Life data for that printer is available. Components that are not utilized in any of the available functions are excluded in the evaluation of Equation 4 because subsequent uses of that printer will not induce further wear on those components. Those components will never wear down unless the conditions that inhibit the associate functions are rectified. During the periodic updates the wear information from the printer will supersede the corresponding entries in Table 1. The Residual Life estimates made between printer updates are then replaced with accurate values from the printer. The state-of-wear values for all printers will in turn be available for Module 450 when the next print job arrives. Finally, based on the residual life values of all the printers and average job sizes the server can provide the customer with a suggested service schedule.

Unlike what is commonly seen in a printer driver on a Microsoft Windows operating system, the printer selection can be made transparent to the user. If necessary, information regarding timing and location of delivery can be provided. The preferences weights can be set automatically based on predefined profiles. Also, a user preference wizard based on high-level questions may be used. For example, when a user is ready to print a document, the user may specify any printer in a certain room that will provide stapled color printouts on regular quality paper stock. These desired functions are thus specified in lieu of the common practice of first specifying a printer and then specifying further printer functions that are offered on a single printer.

While the present discussion has been illustrated and described with reference to specific embodiments, further modification and improvements will occur to those skilled in the art. Additionally, “code” as used herein, or “program” as used herein, is any plurality of binary values or any executable, interpreted or compiled code which can be used by a computer or execution device to perform a task. This code or program can be written in any one of several known computer languages. A “computer”, as used herein, can mean any device which stores, processes, routes, manipulates, or performs like operation on data. It is to be understood, therefore, that this disclosure is not limited to the particular forms illustrated and that it is intended in the appended claims to embrace all alternatives, modifications, and variations which do not depart from the spirit and scope of the embodiments described herein.

What is claimed:

1. A computerized method for the management of job distribution among a population of networked production machines through balancing of the usage load over the population of networked machines based upon wear data of the networked production machines, the method comprising:
initializing a production server, wherein said production server communicates with the networked production machines;
synchronizing wear rate for each monitored component within each networked production machine, wherein said wear rate is the amount of service life lost per unit of product produced, and wherein said service life is the averaged expected life for said monitored component;
synchronizing residual life for each monitored component within each networked production machine, wherein said residual life is an estimate of the amount of remaining service life for each networked production machine;
communicating the residual life value for each networked production machine to said production server;
determining whether a job request has arrived, wherein said job request includes individual production elements;
rechecking the job request status if a job request has not been received;
selecting at least one production machine to perform said job if said job request has arrived, wherein selecting said at least one production machine is based on the state of wear of each networked production machine with the use of a decision algorithm that shapes wear patterns across all of the networked production machines according to a wear policy;
routing said job to said selected production machine; and
updating the residual life values for said selected production machine, wherein said updated residual life values comprise a more detailed estimate of incremental wear on said selected production machine based on the requirements of said job.

2. The computerized method for the management of job distribution according to claim 1, wherein said networked production machines comprise networked printers.

3. The computerized method for the management of job distribution according to claim 1, wherein said monitored components comprise individual components or replaceable subassemblies.

4. The computerized method for the management of job distribution according to claim 1, wherein said residual life estimate comprises the number of individual production elements remaining that can be delivered by the monitored components with the least residual life.

5. The computerized method for the management of job distribution according to claim 1, wherein said wear policy comprises minimization of wear variance among said production machines.

6. The computerized method for the management of job distribution according to claim 1, wherein said wear policy comprises a preference for using production machines for which consumables are available.

7. The computerized method for the management of job distribution according to claim 1, further comprising function analysis, wherein said function analysis includes analyzing the content of said job to identify the resources and functions required by said job.

8. The computerized method for the management of job distribution according to claim 1, further comprising conversion of individual production elements to component wear coefficients for said selected production machine.

9. The computerized method for the management of job distribution according to claim 2, wherein the unit of product produced is in pages.

10. The computerized method for the management of job distribution according to claim 2, further comprising modulating the estimate of residual life with at least one member selected from the group consisting of printer preference, media preference, location preference, print quality preference, and corporate user quota.

11. The computerized method for the management of job distribution according to claim 2, wherein updating said residual life values includes identifying a set of job parameters, wherein said job parameters include at least one member selected from the group consisting of number of pages to be printed, simplex printing, duplex printing, and number of pixels for each toner color.

12. A computerized system for the management of job distribution among a population of networked production machines through balancing of the usage load over the population of networked machines based upon wear data of the networked production machines, the system comprising:
production server, wherein said production server communicates with the networked production machines;
wear estimation module for synchronizing wear rate and residual life for each monitored component within each networked production machine;
residual life module for communicating the residual life value for each networked production machine to said production server;
job routing module for receiving job requests and selecting at least one production machine to perform said job if said job request has arrived, wherein selecting said at least one production machine is based on the state of wear of each networked production machine with the use of a decision algorithm that shapes wear patterns across all of the networked production machines according to a wear policy;
data mapping module for updating the residual life values for said selected production machine, wherein said updated accumulated wear values comprise a more detailed estimate of incremental wear on said selected production machine based on the requirements of said job.

13. The computerized system for the management of job distribution according to claim 12, wherein said wear rate is the amount of service life lost per unit of product produced, and wherein said service life is the averaged expected life for said monitored component.

14. The computerized system for the management of job distribution according to claim 12, wherein said residual life is an estimate of the amount of remaining service life for each networked production machine.

15. The computerized system for the management of job distribution according to claim 12, wherein said networked production machines comprise networked printers.

16. The computerized system for the management of job distribution according to claim 12, wherein said monitored components comprise and individual components or replaceable subassemblies.

17. The computerized system for the management of job distribution according to claim 12, wherein said residual life estimate comprises the number of individual production elements remaining that can be delivered by the monitored components with the least residual life.

18. The computerized system for the management of job distribution according to claim 12, wherein said wear policy comprises minimization of wear variance among said production machines.

19. The computerized system for the management of job distribution according to claim 12, wherein said wear policy comprises a preference for using production machines for which consumables are available.

20. The computerized system for the management of job distribution according to claim 12, further comprising at least one function table module, wherein said function table module maintains resource and function availability data.

21. The computerized system for the management of job distribution according to claim 12, further comprising conversion of individual production elements to component wear coefficients for said selected production machine.

22. The computerized system for the management of job distribution according to claim 15, wherein the unit of product produced is in pages.

23. The computerized system for the management of job distribution according to claim 15, wherein updating said residual life values includes identifying a set of job parameters, wherein said job parameters include at least one member selected from the group consisting of number of pages to be printed, simplex printing, duplex printing, and number of pixels for each toner color.

24. An article of manufacture comprising a computer usable medium having computer readable program code embodied in said medium which, when said program code is executed by said computer causes said computer to perform method steps for the management of job distribution among a population of networked production machines through balancing of the usage load over the population of networked machines based upon wear data of the networked production machines, the method comprising:
initializing a production server, wherein said production server communicates with the networked production machines;
synchronizing wear rate for each monitored component within each networked production machine, wherein said wear rate is the amount of service life lost per unit of product produced, and wherein said service life is the averaged expected life for said monitored component;
synchronizing residual life for each monitored component within each networked production machine, wherein said residual life is an estimate of the amount of remaining service life for each networked production machine;
communicating the residual life value for each networked production machine to said production server;
determining whether a job request has arrived, wherein said job request includes individual production elements;
rechecking the job request status if a job request has not been received;
selecting at least one production machine to perform said job if said job request has arrived, wherein selecting said at least one production machine is based on the state of wear of each networked production machine with the use of a decision algorithm that shapes wear patterns across all of the networked production machines according to a wear policy;
routing said job to said selected production machine; and
updating the residual life values for said selected production machine, wherein said updated accumulated wear values comprise a more detailed estimate of incremental wear on said selected production machine based on the requirements of said job.
